(19) United States
(12) Patent Application Publication
(10) Pub. No.: US 2023/0368238 A1
(43) Pub. Date: Nov. 16, 2023

(54) METHOD AND SYSTEM FOR PROVIDING LOYALTY POINTS TO CUSTOMERS

(71) Applicant: KLOSEBUY, INC., Davie, FL (US)

(72) Inventor: William Frank Fennell, DAVIE, FL (US)

(21) Appl. No.: 17/742,618

(22) Filed: May 12, 2022

(51) Int. Cl. G06Q 30/02

(52) U.S. Cl. CPC G06Q 30/0231; G06Q 30/0246; G06Q 30/0212; G06Q 30/0201

(57) ABSTRACT

A system for providing loyalty points to one or more customers is described. The system comprises, one or more business devices, one or more customer devices, and a loyalty reward system, where the loyalty reward system communicatively coupled to the one or more business devices and the one or more customer devices. The loyalty reward system is configured to generate digital promotional content based on obtained information associated with one or more attributes of one or more promotional offers provided by a business. The loyalty reward system is further configured to track customer activities associated with the generated digital promotional content. Upon receiving a request from the business device, the loyalty reward system provide loyalty points to the respective one or more customer device, when the one or more customer activities meet predefined activity conditions.

### BACKGROUND OF THE INVENTION

The economic impact of customer retention is immeasurable. It has been proven that the number one factor in determining how fast a business's profits grow is directly proportionate to retaining existing customers and attracting new ones. In order to retain customers, businesses often provide different types of offers and plans that match their needs. The more specific the offer or plan is with what a particular customer wants, the better chance they'll take advantage from by purchasing.

### BRIEF DESCRIPTION OF THE SEVERAL VIEWS OF THE DRAWINGS

The accompanying figures, where like reference numerals refer to identical or functionally similar elements throughout the separate views, together with the detailed description below, are incorporated in and form part of the specification, and serve to further illustrate embodiments of concepts that include the claimed invention and explain various principles and advantages of those embodiments.

FIG. 1 illustrates an exemplary system including a loyalty reward system for providing loyalty points, in accordance with some embodiments;

FIG. 2 illustrates a block diagram of an exemplary business device, in accordance with some embodiments;

FIG. 3 illustrates a block diagram of an exemplary customer device, in accordance with some embodiments;

FIG. 4 illustrates an exemplary sign-up form displayed on the business device for signing up with the loyalty reward system, in accordance with some embodiments;

FIG. 5 illustrates an exemplary promotional content generation web form displayed on the business device for obtaining information associated with a business, in accordance with some embodiments;

FIG. 6 illustrates an exemplary promotional content displayed on the customer device, in accordance with some embodiments;

FIG. 7 illustrates an exemplary promotional content tracking chart displayed on the business device, in accordance with some embodiments;

FIG. 8 illustrates an exemplary loyalty reward creation web form displayed on the business device for obtaining information associated with loyalty rewards offered by the business, in accordance with some embodiments;

FIG. 9 illustrates exemplary loyalty rewards displayed on the customer device, in accordance with some embodiments;

FIG. 10 illustrates an exemplary sweepstake offer displayed on the customer device for redeeming bonus points, in accordance with some embodiments; and

FIG. 11 illustrates an exemplary method for providing loyalty points, in accordance with some embodiments;

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION OF THE INVENTION

In one aspect, a system for providing loyalty points to one or more customers is described. The system comprises one or more business devices and one or more customer devices. Each of the one or more business devices are configured to initiate a request to provide the loyalty points and each of the one or more customer devices are configured to receive the loyalty points. The system further comprises a loyalty reward system communicatively coupled to the one or more business devices and the one or more customer devices. The loyalty reward system is configured to provide, to the one or more business devices, a web form to obtain information associated with one or more attributes of one or more promotional offers provided by a business upon initiation of the request. The loyalty reward system is further configured to obtain, from the one or more business devices, information associated with the one or more attributes via the web form and generate digital promotional content based on the obtained information. Further, the loyalty reward system is configured to track, on the one or more customer devices, one or more customer activities associated with the generated digital promotional content by determining one or more of: a number of times the generated digital promotional content is shared on each of the one or more customer devices, a number of times the generated digital promotional content was utilized to redeem the one or more promotional offers on each of the one or more customer devices, a number of times the generated digital promotional content was viewed on the one or more customer devices, and a number of times the generated digital promotional content was saved on each of the one or more customer devices. The loyalty reward system is further configured to provide the loyalty points, to the respective one or more customer devices when the one or more customer activities meet predefined activity conditions, wherein the predefined activity conditions are defined based on preferences of the business.

In another aspect, a method for providing loyalty points to one or more customers is described. The method comprises providing, to one or more business devices, a web form to obtain information associated with one or more attributes of one or more promotional offers provided by a business. Each of the one or more business devices are configured to initiate a request to provide the loyalty points. The method further comprises obtaining, from the one or more business devices, information associated with the one or more attributes via the web form. Further, the method comprises generating digital promotional content, based on the obtained information. The method further comprises, tracking, on one or more customer devices, one or more customer activities associated with the generated digital promotional content by determining one or more of: a number of times the generated digital promotional content is shared on each of the one or more customer devices, a number of times the generated digital promotional content was utilized to redeem the one or more promotional offers on each of the one or more customer devices, a number of times the generated digital promotional content was viewed on the one or more customer devices, and a number of times the generated digital promotional content was saved on each of the one or more customer devices. The method further comprises providing the loyalty points to the respective one or more customer devices when the one or more customer activities meet predefined activity conditions. The predefined activity conditions are defined based on preferences of the business, and each of the one or more customer devices are configured to receive the loyalty points.

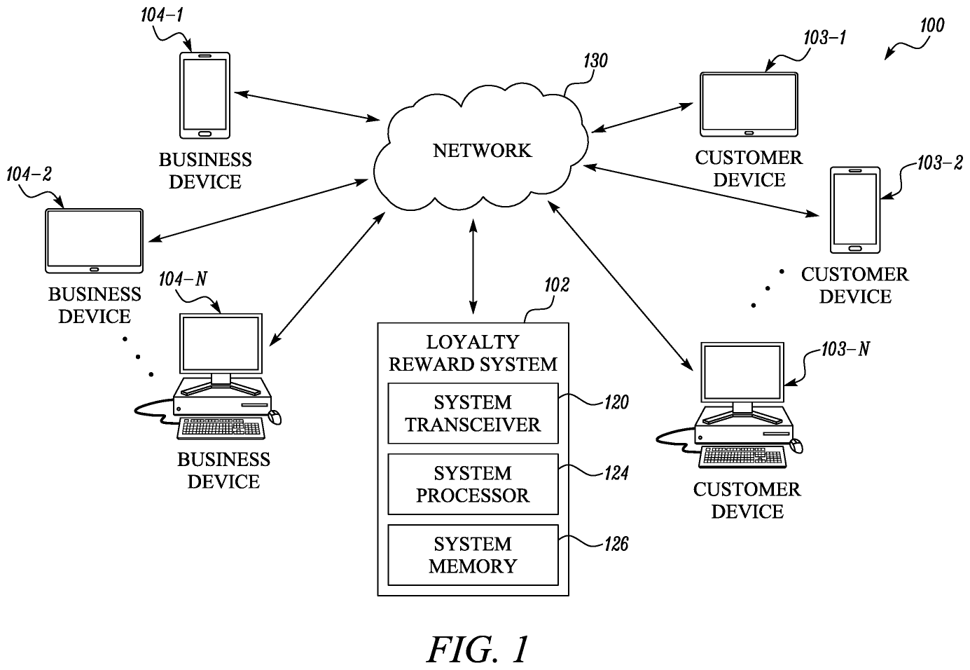

FIG. 1 illustrates an system 100 implementing an exemplary loyalty reward system 102 in accordance with various embodiments. The loyalty reward system 102 is configured to enable one or more business devices such as 104-1, 104-2, . . . 104-n, to provide the loyalty points to one or more customer devices 103-1, 103-2, . . . 103-n. For example, the loyalty points correspond to a first set of reward points offered by a business associated with the business device 104 to the one or more customer devices 103 to redeem loyalty rewards, for example, discounts, deals, or the like on product and/or services offered by the business. In accordance with some embodiments, the loyalty reward system 102 is configured to provide bonus points to the one or more customer devices 103. For example, the bonus points correspond to a second set of reward points provided to the one or more customer devices 103 to participate in one or more sweepstake contests offered by the loyalty reward system 102.

The business devices 104 and the customer devices 103 are communicatively coupled to and communicate with the loyalty reward system 102 over a communication network 130. The communication network 130 may include, but is not limited to, a wide area network (WAN) (for example, a transport control protocol/internet protocol (TCP/IP) based network), a cellular network, or a local area network (LAN) employing any of a variety of communications protocols as is now known or in the future developed.

Each of the business devices 104, operates as an interface for a corresponding business interacting with the loyalty reward system 102. For example, the business may be, but not limited to, restaurants, bakeries, retail shops, entertainment venues, and the like. Each business utilizes the respective business device 104 to initiate a request, to provide the loyalty points to the one or more customer devices 103.

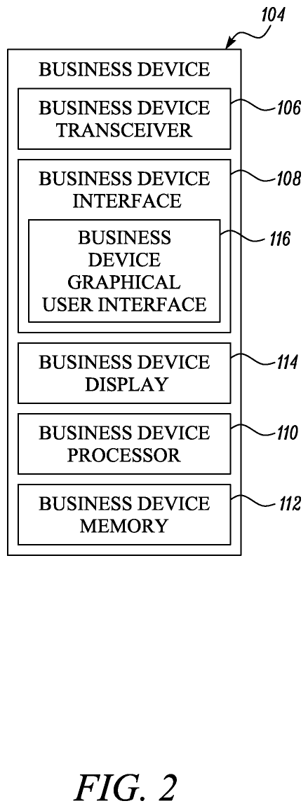

Each business device 104 includes a plurality of electrical and electronic components, providing power, operational control, communication, and the like within the business device 104. The various components of the business device 104 will now be described hereinafter with respect to FIG. 2. It should be appreciated by those of ordinary skill in the art that FIG. 2 depicts the business device 104 in a simplified manner and a practical embodiment may include additional components and suitably configured logic to support known or conventional operating features that are not described in detail herein. It will further be appreciated by those of ordinary skill in the art that the business device 104 is a personal computer, desktop computer, tablet, smartphone, or any other computing device now known or developed in the future. Although the business device 104 is shown and described to be implemented within a single computing device, it may be contemplated that the one or more components of the business device 104 may alternatively be implemented in a distributed computing environment.

The business device 104 includes, among other components, a business device transceiver 106, a business device interface 108, a business device display 114, a business device processor 110, and a business device memory 112. The components of the business device 104, including the business device transceiver 106, the business device interface 108, the business device display 114, the business device processor 110, and the business device memory 112, cooperate with one another to enable operations of the business device 104. Each component may communicate with one another via a local interface (not shown). The local interface may be, such as, but not limited to, one or more buses or other wired or wireless connections, as is known in the art. The local interface may have additional elements, which are omitted for simplicity, such as controllers, buffers (caches), drivers, repeaters, and receivers, among many others, to enable communications. Further, the local interface may include address, control, and/or data connections to enable appropriate communications among the aforementioned components.

As illustrated, the business device 104 includes the business device transceiver 106 to provide one or more inputs to and receive the one or more outputs from other devices, such as, the loyalty reward system 102. The business device transceiver 106 includes a transmitter circuitry and a receiver circuitry to enable the business device 104 to communicate data to and acquire data from the loyalty reward system 102. In this regard, the transmitter circuitry includes appropriate circuitry to provide the one or more requests and inputs (as discussed in detail in the forthcoming description) associated with providing the loyalty points to the one or more customer devices 103. Similarly, the receiver circuitry includes appropriate circuitry to receive the one or more outputs and data (as discussed in detail in the forthcoming description) associated with providing the loyalty points to the one or more customer devices 103. It will be appreciated by those of ordinary skill in the art that the business device 104 may include a single business device transceiver 106 as shown, or alternatively separate transmitting and receiving components, for example but not limited to, a transmitter, a transmitting antenna, a receiver, and a receiving antenna.

In accordance with various embodiments, the business device interface 108 is configured to receive input from and/or provide output to the business user. The input may be provided via a keyboard, a touch screen display (such as, the business device display 114), a camera, a touch pad, a microphone, a recorder, a mouse, or any other user input mechanism now known or developed in the future. The output may be provided via a display device, such as the business device display 114, a speaker, a haptic output, or any other output mechanism now known or developed in the future. The business device interface 108 may further include a serial port, a parallel port, an infrared (IR) interface, a universal serial bus (USB) interface and/or any other interface herein known or developed in the future.

In accordance with some embodiments, the business device interface 108 includes a business device graphical user interface 116 through which the business user communicates with the loyalty reward system 102. The business device graphical user interface 116 may be an application or web portal or any other suitable interface. The business device graphical user interface 116 includes one or more of graphical elements associated with providing the loyalty points to the one or more customer devices 103, providing information to the loyalty reward system 102 via one or more web forms, and the like. The graphical elements may include, but not limited to one or more of image icons, control buttons, selection boxes, pull-down menus, on-off checkmarks, scroll bars, dialogue boxes, window, and/or web forms. The graphical elements may be used in conjunction with text to prompt the business user for an input or display information to the business user in response to the one or more instructions from the loyalty reward system 102.

The business device display 114 is configured to display web forms, data, images, and the like. The business device display 114 includes a display screen or a computer monitor now known or in the future developed. In accordance with some embodiments, the business device display 114 is configured to display the business device graphical user interface 116 associated with providing the loyalty points to the one or more customer devices 103.

The business device memory 112 is a non-transitory memory configured to store a set of instructions that are executable by the business device processor 110 to perform predetermined operations. For example, the business device memory 112 may include any of the volatile memory elements (for example, random access memory (RAM)), nonvolatile memory elements (for example, read only memory (ROM)), and combinations thereof. Moreover, the business device memory 112 may incorporate electronic, magnetic, optical, and/or other types of storage media. In accordance with some embodiments, the business device memory 112 is also configured to store data associated with providing the loyalty points to the one or more customer devices 103.

The business device processor 110 is configured to execute the instructions stored in the business device memory 112 to perform the predetermined operations, for example, the detailed functions of the business device 104 as will be described in the forthcoming disclosure. The business device processor 110 may include one or more microprocessors, microcontrollers, DSPs (digital signal processors), state machines, logic circuitry, or any other device or devices that process information or signals based on operational or programming instructions. The business device processor 110 may be implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The business device processor 110 is configured to cooperate with other components of the business device 104 to perform operations pursuant to communications and the one or more instructions from the loyalty reward system 102.

Referring back to FIG. 1, the system 100 also includes one or more customer devices 103, such as, 103-1, 103-2, . . . 103-n, communicating with the loyalty reward system 102 over the communication network 130. Each of the one or more customer devices 103 operate as an interface for a corresponding customer interacting with the loyalty reward system 102. In an embodiment, the customer device 103 is configured to receive the loyalty points and/or the bonus points from the loyalty reward system 102.

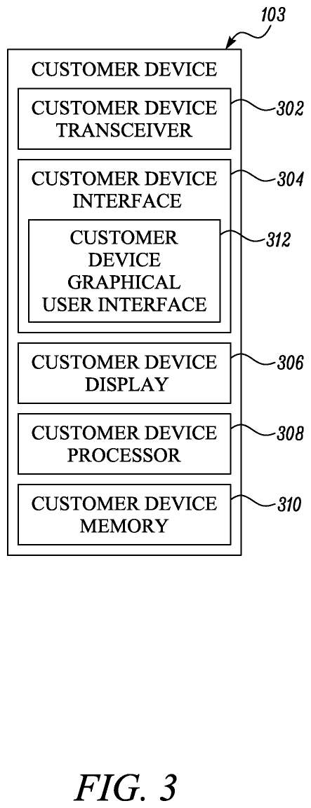

FIG. 3 illustrates the customer device 103 in a simplified manner and a practical embodiment may include additional components and suitably configured logic to support known or conventional operating features that are not described in detail herein. Each customer device 103 includes a plurality of electrical and electronic components, providing power, operational control, communication, and the like within the customer device 103. The various components of the customer device 103 will now be described hereinafter. It will further be appreciated by those of ordinary skill in the art that the customer device 103 is a personal computer, desktop computer, tablet, smartphone, or any other computing device now known or developed in the future. Although the customer device 103 is shown and described to be implemented within a single computing device, it may be contemplated that the one or more components of the customer device 103 may alternatively be implemented in a distributed computing environment.

The customer device 103 includes, among other components, a customer device transceiver 302, a customer device interface 304, a customer device display 306, a customer device processor 308, and a customer device memory 310. The components of the customer device 103, including the customer device transceiver 302, the customer device interface 304, the customer device display 306, the customer device processor 308, and the customer device memory 310, cooperate with one another to enable operations of the customer device 103. Each component may communicate with one another via a local interface (not shown). The local interface may be, such as, but not limited to, one or more buses or other wired or wireless connections, as is known in the art. The local interface may have additional elements, which are omitted for simplicity, such as controllers, buffers (caches), drivers, repeaters, and receivers, among many others, to enable communications. Further, the local interface may include address, control, and/or data connections to enable appropriate communications among the aforementioned components.

As illustrated, the customer device 103 in the exemplary embodiment includes the customer device transceiver 302 to provide one or more inputs to and receive the one or more outputs from other devices, such as, the loyalty reward system 102. The customer device transceiver 302 includes a transmitter circuitry and a receiver circuitry to enable the customer device 103 to communicate data to and acquire data from the loyalty reward system 102. In this regard, the transmitter circuitry includes appropriate circuitry to provide the one or more inputs, such as, but not limited to, associated with obtaining and redeeming the loyalty points and/or the bonus points, to the loyalty reward system 102. Similarly, the receiver circuitry includes appropriate circuitry to receive the one or more outputs, such as, but not limited to, the loyalty points and the bonus points, from the loyalty reward system 102. It will be appreciated by those of ordinary skill in the art that the customer device 103 may include a single customer device transceiver 302 as shown, or alternatively separate transmitting and receiving components, for example but not limited to, a transmitter, a transmitting antenna, a receiver, and a receiving antenna.

The customer device interface 304 is configured to receive input from and/or to provide output to a customer. The input may be provided via a keyboard, a touch screen display, a camera, a touch pad, a microphone, a recorder, a mouse, or any other user input mechanism now known or developed in the future. The output may be provided via a display device, such as the customer device display 306, a speaker, a haptic output, or any other output mechanism now known or developed in the future. The customer device interface 304 may further include a serial port, a parallel port, an infrared (IR) interface, a universal serial bus (USB) interface and/or any other interface herein known or developed in the future.

In accordance with some embodiments, the customer device interface 304 includes a customer device graphical user interface 312 through which the customer communicates with the loyalty reward system 102. The customer device graphical user interface 312 may be an application or web portal or any other suitable interface, with one or more graphical elements, to receive or obtain the loyalty points, the bonus points, and the like. The graphical elements may include, but not limited to one or more of image icons, control buttons, selection boxes, pull-down menus, on-off checkmarks, scroll bars, dialogue boxes, window, and/or web forms. The graphical elements may be used in conjunction with text to prompt the customer for an input or display information to the customer in response to the one or more instructions from the loyalty reward system 102.

The customer device display 306 is configured to display webforms, data, images, and the like. The customer device display 306 includes a display screen or a computer monitor now known or in the future developed. In accordance with some embodiments, the customer device display 306 is configured to display the customer device graphical user interface 312 associated with display of the loyalty points, the bonus points, the loyalty rewards, the sweepstake contests, and the like.

The customer device memory 310 is a non-transitory memory configured to store a set of instructions that are executable by the customer device processor 308 to perform predetermined operations. For example, the customer device memory 310 may include any of the volatile memory elements (for example, random access memory (RAM)), nonvolatile memory elements (for example, read only memory (ROM)), and combinations thereof. Moreover, the customer device memory 310 may incorporate electronic, magnetic, optical, and/or other types of storage media. In accordance with some embodiments, the customer device memory 310 is also configured to store files, such as but not limited to, details regarding the loyalty points and the bonus points.

The customer device processor 308 is configured to execute the instructions stored in the customer device memory 310 to perform the predetermined operations, for example, the detailed functions of the customer device 103 as will be described in the forthcoming disclosure. The customer device processor 308 may include one or more microprocessors, microcontrollers, DSPs (digital signal processors), state machines, logic circuitry, or any other device or devices that process information or signals based on operational or programming instructions. The customer device processor 308 may be implemented using one or more controller technologies, such as Application Specific Integrated Circuit (ASIC), Reduced Instruction Set Computing (RISC) technology, Complex Instruction Set Computing (CISC) technology, or any other similar technology now known or in the future developed. The customer device processor 308 is configured to cooperate with other components of the customer device 103 to perform operations pursuant to communications and the one or more instructions from the loyalty reward system 102.

Referring back to FIG. 1, the loyalty reward system 102 is configured to provide the loyalty points and/or the bonus points to the one or more customer devices 103. In accordance with some embodiments, the loyalty reward system 102 includes a plurality of electrical and electronic components, providing power, operational control, communication, and the like within the loyalty reward system 102. For example, the loyalty reward system 102 includes, among other components, a system transceiver 120, a system processor 124, and a system memory 126. It should be appreciated by those of ordinary skill in the art that FIG. 1 depicts the loyalty reward system 102 in a simplified manner and a practical embodiment may include additional components and suitably configured logic to support known or conventional operating features that are not described in detail herein. It will further be appreciated by those of ordinary skill in the art that the loyalty reward system 102 may be a personal computer, desktop computer, tablet, smartphone, or any other computing device now known or developed in the future.

Further, although the loyalty reward system 102 is shown and described to be implemented within a single computing device, it may be contemplated that the one or more components of the loyalty reward system 102 may alternatively be implemented in a distributed computing environment, without deviating from the scope of the claimed subject matter. It will further be appreciated by those of ordinary skill in the art that the loyalty reward system 102 alternatively may function within a remote server, cloud computing device, or any other remote computing mechanism now known or developed in the future. The loyalty reward system 102 may be a cloud environment incorporating the operations of the system transceiver 120, the system processor 124, and the system memory 126, and various other operating modules to serve as a software as a service model for the business devices 104 and the customer devices 103. In an embodiment, the loyalty reward system 102 and the business device 104 may be one computing device incorporating the operations of all the components of the loyalty reward system 102 and the business device 104.

The components of the loyalty reward system 102, including the system transceiver 120, the system processor 124, and the system memory 126 may communicate with one another via a local interface (not shown). The local interface may be, namely, but not limited to, one or more buses or other wired or wireless connections, as is known in the art. The local interface may have additional elements, but not limited to, such as controllers, buffers (caches), drivers, repeaters, and receivers, among many others, to enable communications. Further, the local interface may include address, control, and/or data connections to enable appropriate communications among the aforementioned components.

The system transceiver 120 includes a transmitter circuitry and a receiver circuitry (not shown) to enable the loyalty reward system 102 to communicate data to and acquire data from other devices such as the business devices 104 and the customer devices 103. In this regard, the transmitter circuitry may include appropriate circuitry to transmit data associated with the loyalty points to the business devices 104 and the customer devices 103. In accordance with some embodiments, the transmitter circuitry is configured to transmit data associated with the bonus points to the customer devices 103. Similarly, the receiver circuitry may include appropriate circuitry to receive data associated with the loyalty points from the business devices 104 and the customer devices 103. In accordance with some embodiments, the receiver circuitry is configured to receive data associated with the bonus points from the customer devices 103. The transmitter circuitry and the receiver circuitry together form a wireless transceiver to enable wireless communication with the business devices 104 and the customer devices 103. It will be appreciated by those of ordinary skill in the art that the loyalty reward system 102 may include a single system transceiver 120 as shown, or alternatively separate transmitting and receiving components, for example but not limited to, a transmitter, a transmitting antenna, a receiver, and a receiving antenna.

The system memory 126 is a non-transitory memory configured to store a set of instructions that are executable by the system processor 124 to perform the predetermined operations. For example, the system memory 126 may include any of the volatile memory elements (for example, random access memory (RAM)), nonvolatile memory elements (for example read only memory (ROM)), and combinations thereof. Moreover, the system memory 126 may incorporate electronic, magnetic, optical, and/or other types of storage media. In accordance with some embodiments, the system memory 126 is also configured to store data associated with the generation and redemption of the loyalty points and/or the bonus points.

The system processor 124 is configured to execute the instructions stored in the system memory 126 to perform the predetermined operations, for example, the detailed functions of the loyalty reward system 102 as will be described hereinafter. The system processor 124 may include one or more microprocessors, microcontrollers, DSPs (digital signal processors), state machines, logic circuitry, or any other device or devices that process information or signals based on operational or programming instructions. The system processor 124 may be implemented using one or more controller technologies, such as Application Specific Integrated Circuit (ASIC), Reduced Instruction Set Computing (RISC) technology, Complex Instruction Set Computing (CISC) technology, or any other technology now known or in the future developed.

In operation, the loyalty reward system 102 is configured to obtain a request, from the business device 104, to provide the loyalty points to one or more customer devices 103. To this end, the loyalty reward system 102 is configured to generate digital promotional content for the one or more customer devices 103 and provide the loyalty points to the one or more customer devices 103 based on customer activities associated with the generated digital promotional content on the respective one or more customer devices 103. For example, the digital promotional content may include, but is not limited to, details related to promotion of services, products, deals, discounts, and rewards offered by the business associated with the business device 104. In an embodiment, the business device 104 may transmit the request to the loyalty reward system 102, for example, via one or more graphical elements on the business device graphical user interface 116. Upon receiving the request, the loyalty reward system 102 is configured to determine whether the business device 104 is registered with the loyalty reward system 102.

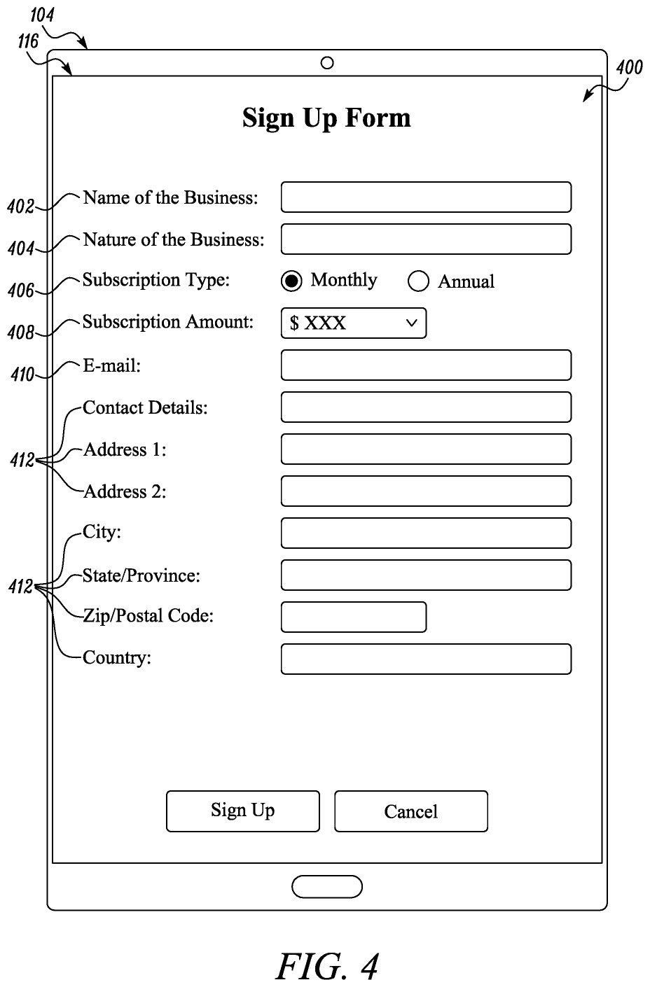

In an embodiment, upon determination that the business device 104 is not registered with the loyalty reward system 102, the loyalty reward system 102 is configured to provide, one or more instructions, to the business device 104, to obtain one or more parameters related to the business associated with the business device 104. For example, the one or more instructions may include a sign-up form 400 as illustrated in FIG. 4. The sign-up form 400 may include the one or more parameters like, but not limited to, name 402, nature 404 (for example, food, retail, entertainment venue, and the like), subscription type 406 (for example, annual subscription, monthly subscription, and the like), subscription amount 408, email 410, and other contact details 412 (for example, address, city, zip code, country and the like) of the business. The loyalty reward system 102 is configured to obtain information associated with the one or more parameters, for example, via the business device graphical user interface 116 and register the business device 104 with the loyalty reward system 102. In some embodiments, the loyalty reward system 102 is configured to store the obtained information in the system memory 126.

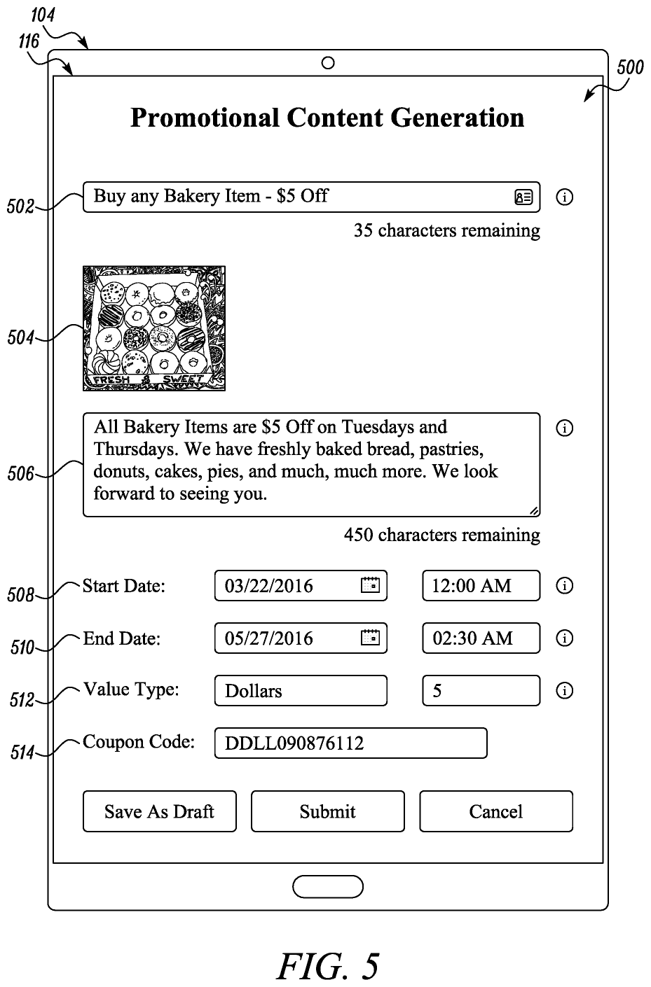

In accordance with various embodiments, when the loyalty reward system 102 determines that the business device 104 is registered with the loyalty reward system 102, the loyalty reward system 102 is configured to obtain information associated with one or more promotional offers provided by the business from the business device 104. In an exemplary embodiment, the loyalty reward system 102 is configured to provide, to the business device 104, a web form 500 (as illustrated in FIG. 5) to obtain information associated with one or more attributes of the one or more promotional offers provided by the business. For example, the one or more promotional offers may include promotion of, but not limited to, services, products, deals, discounts, and rewards offered by the business associated with the business device 104. The one or more attributes of the one or more promotional offers may include at least one of: a title 502, an image 504, descriptive details 506, a start date 508, an end date 510, a coupon code 514 for redemption, price value 512 for which the discount is offered, and the like, associated with the one or more promotional offers.

The loyalty reward system 102 is configured to provide one or more instructions to the business device 104 to prompt the business user, for example, via the web form 500 displayed on the business device graphical user interface 116 (as shown in FIG. 5), to provide the information associated with the one or more attributes. In an embodiment, upon receiving the information from the business device 104, the loyalty reward system 102 is configured to store the information in the system memory 126.

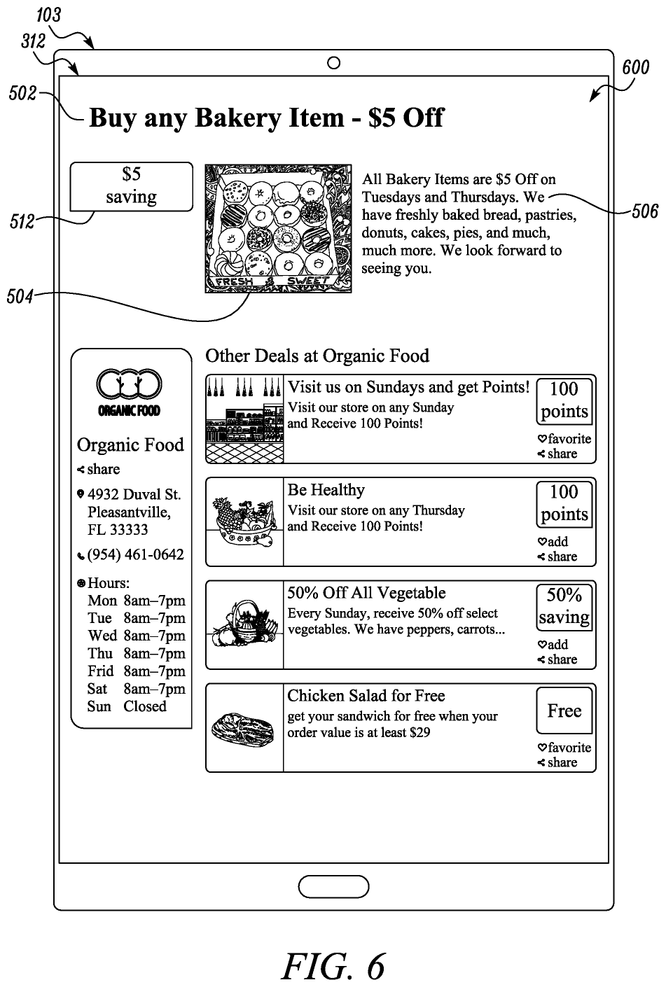

In accordance with various embodiments, upon obtaining the information via the web form 500, the loyalty reward system 102 is configured to generate digital promotional content based on the obtained information. For example, the loyalty reward system 102 generates the digital promotional content 600 (shown in FIG. 6) based on the information, such as, the image 504, the title 502, the price value 512, descriptive details 506, and the like obtained, for example, via the web form 500 (shown in FIG. 5) from the business device 104. In accordance with various embodiments, the loyalty reward system 102 is configured to provide one or more instructions to the one or more customer devices 103 to display the generated promotional content on the respective customer device graphical user interface 312. For example, FIG. 6 illustrates the generated digital promotional content 600 displayed on the customer device graphical user interface 312 of the customer device 103.

In accordance with some embodiments, the loyalty reward system 102 is configured to receive a request from the business device 104, for example, via the business device graphical user interface 116, to edit the generated promotional content. Upon receiving the request, the loyalty reward system 102 is configured to retrieve and display the web form, for example, the web form 500 (shown in FIG. 5), corresponding to the generated digital promotional content on the business device display 114 of the business device 104. The business device 104 is configured to modify the information previously obtained and associated with the one or more attributes based on which the previous digital promotional content was generated. Upon obtaining the modified information, the loyalty reward system 102 is configured to generate an updated digital promotional content based on the modified information associated with the one or more attributes. In accordance with various embodiments, the loyalty reward system 102 is configured to provide one or more instructions to the one or more customer devices 103 to display the updated promotional content on the respective customer device graphical user interface 312.

In accordance with various embodiments, the loyalty reward system 102 is configured to receive a request from the business device 104, to generate one or more codes for the customer device 103 to redeem one or more promotional offers in the displayed digital promotional content. For example, the loyalty reward system 102 may receive a request from the business device 104 to generate a code to enable the customer device 103 to redeem the promotional offer of $5 off on the bakery items, as illustrated in FIG. 6. In accordance with various embodiments, the request may include the request to generate one or more codes selected from a group comprising one or more of a Quick Response (“QR”) code and a barcode. The one or more QR code and the barcode may be a single-use or multi-use codes. To this end, the loyalty reward system 102 is configured to generate one or more codes, for example, a QR code or a barcode, corresponding to the promotional offer based on the received request. Upon generation of the one or more codes, the loyalty reward system 102 is configured to transmit the generated one or more codes corresponding to the one or more promotional offers on each of the one or more customer devices 103.

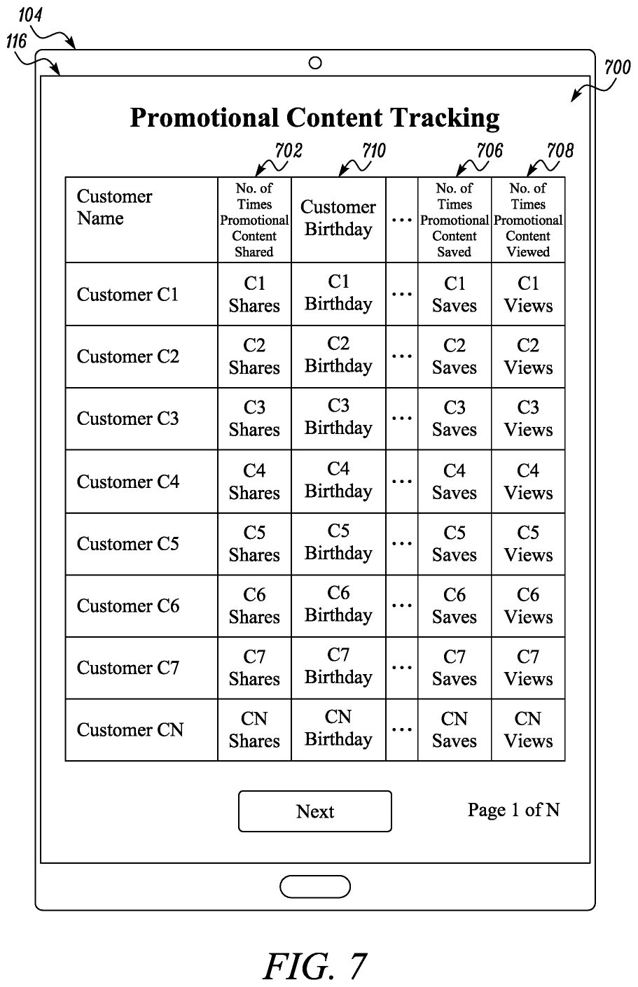

In accordance with various embodiments, the loyalty reward system 102 is configured to track, on the one or more customer devices 103, one or more customer activities associated with the generated digital promotional content. In an embodiment, the loyalty reward system 102 is configured to display the tracked customer activities on the business device 104. For example, FIG. 7 illustrates an exemplary promotional content tracking chart 700, displayed on the business device graphical user interface 116 of the business device 104, depicting the customer activities tracked on the one or more customer devices 103. As shown in FIG. 7, the one or more customer activities include at least one of: a number of times the digital promotional content is shared 702 via the customer device 103, a number of times the digital promotional content is saved 706 on the customer device 103, and a number of times the digital promotional content is viewed 708 on the customer device 103. Although not shown, the one or more customer activities may also include shopping trends of a customer captured by the customer device 103, a number of times the digital promotional content is referred via the customer device 103, a number of times the one or more promotional offers are redeemed by the customer device 103, and the like. As shown in FIG. 7, in some embodiments, the promotional content tracking chart 700 may also include personal details of the customers, for example, customer birthday 710.

In accordance with various embodiments, the loyalty reward system 102 is configured to compare the tracked one or more customer activities on each of the customer device 130 with predefined activity conditions, to provide the loyalty points to the respective one or more customer devices 103. The predefined activity conditions may be one or more conditions associated with the customer activity corresponding to the digital promotion content. For example, the predefined activity condition may correspond to sharing of the digital promotional content by the customer via the customer device 103 for a predetermined number. In an embodiment, the loyalty reward system 102 is configured to enable the business device 104 to define the one or more activity conditions (interchangeably referred to as predefined activity conditions) and the corresponding number of loyalty points. For example, the one or more activity conditions may be defined based on the preferences of the businesses. Upon receiving the one or more activity conditions and the corresponding number of loyalty points, the loyalty reward system 102 is configured to store the one or more activity conditions and the corresponding number of loyalty points in the system memory 126.

In accordance with various embodiments, the loyalty reward system 102 is configured to provide the corresponding number of loyalty points to the customer device 103, when the one or more customer activities on the customer device 103 meet the predefined activity conditions. For example, the loyalty reward system 102 may provide a defined number of loyalty points to the customer device 103, when the customer activities on the customer device 103 correspond to the sharing of the digital promotional content for the predetermined number. In an embodiment, the loyalty reward system 102 may provide the defined number of loyalty points to the customer device 103, for example, in a digital wallet.

In accordance with various embodiments, the loyalty reward system 102 is configured to receive a request from the business device 104, via the business device graphical user interface 116, to update the one or more predefined activity conditions and the corresponding number of loyalty points. Upon receiving the request, the loyalty reward system 102 is configured to prompt the business user associated with the business device 104, for example, via one or more graphical elements on the business device graphical user interface 116, to modify the one or more predefined activity conditions and the corresponding number of loyalty points. In an embodiment, upon receiving the one or more modified activity conditions and the number of loyalty points from the business device 104, the loyalty reward system 102 is configured to update and store the updated one or more predefined activity conditions and the corresponding number of loyalty points in the system memory 126.

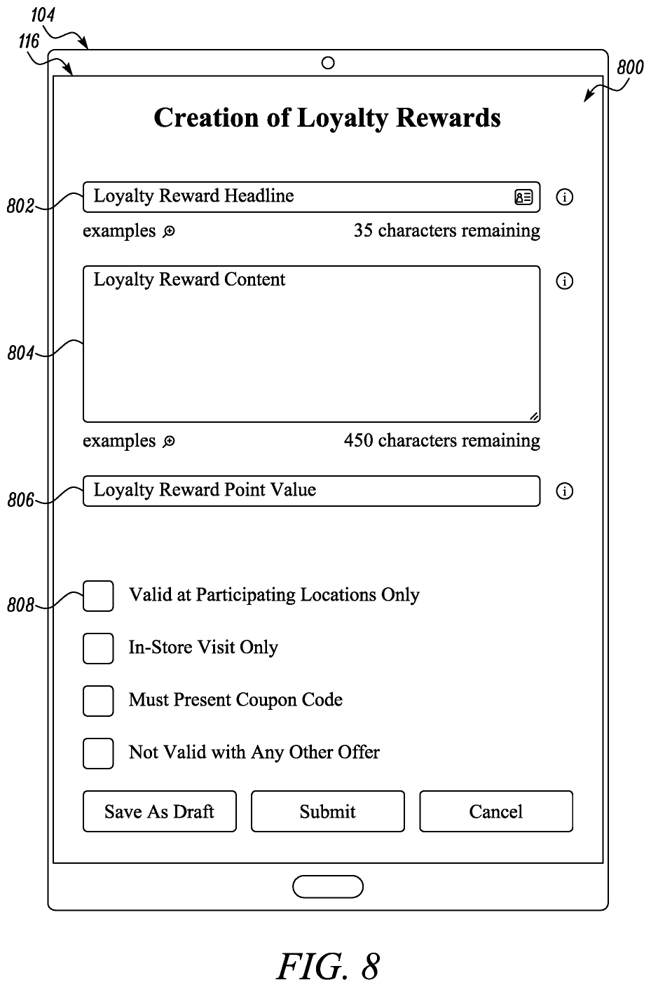

In accordance with various embodiments, the loyalty reward system 102 is configured to enable the customer device 103 to redeem the loyalty points. To this end, the loyalty reward system 102 is configured to generate the loyalty rewards. For example, to generate the loyalty rewards, the loyalty reward system 102 is configured to provide, to the business device 104, a web form 800 (as illustrated in FIG. 8) to obtain information associated with one or more attributes of the one or more loyalty rewards offered by a business. For example, as shown in FIG. 8, the one or more attributes of the one or more loyalty rewards offered by the business may include at least one of: loyalty reward headline 802, loyalty reward content 804 (for example, descriptive details related to the loyalty reward), loyalty reward point value 806 (for example, the number of the loyalty points required to redeem the loyalty reward), or validity of the loyalty reward 808 (for example, whether the loyalty reward is valid at participating locations or at the store), and the like.

The loyalty reward system 102 is configured to provide one or more instructions to the business device 104 to prompt the business user, for example, via the web form 800 displayed on the business device graphical user interface 116, to provide the information associated with the one or more attributes of the one or more loyalty rewards offered by the business. The loyalty reward system 102 is configured to obtain and store the information associated with the one or more attributes of the one or more loyalty rewards offered by the business in the system memory 126.

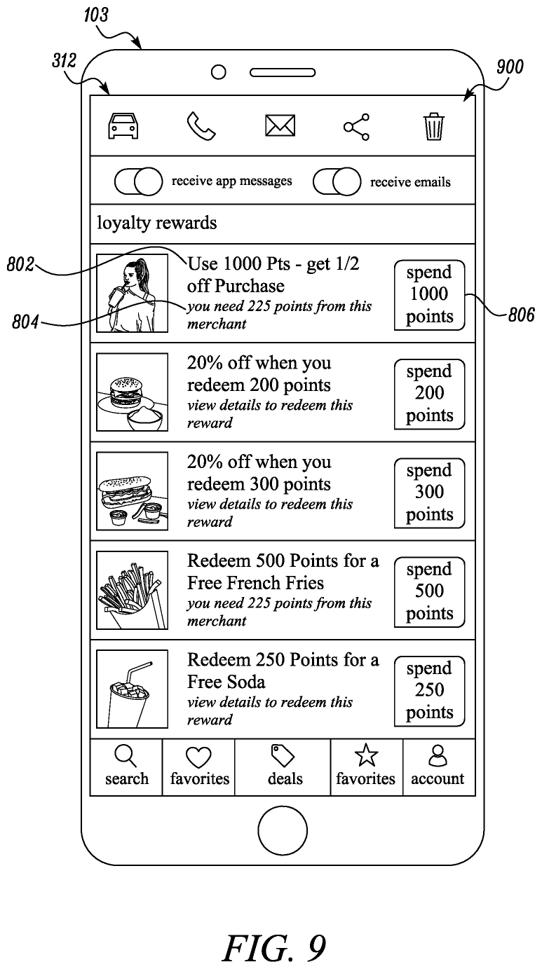

The loyalty reward system 102 is configured to generate the loyalty rewards based on the obtained information associated with the one or more attributes of the one or more loyalty rewards. For example, the loyalty reward system 102 generates the loyalty rewards 900 (as shown in FIG. 9) based on the information, such as, loyalty reward headline 802, loyalty reward content 804, loyalty reward point value 806, and the like obtained via the web form 800 (as shown in FIG. 8). In accordance with various embodiments, the loyalty reward system 102 is configured to provide one or more instructions to the one or more customer devices 103 to display the generated loyalty rewards on the respective customer device graphical user interface 312. For example, FIG. 9 illustrates the generated loyalty rewards 900 displayed on the customer device graphical user interface 312 of the customer device 103.

In accordance with some embodiments, the loyalty reward system 102 is configured to receive a request from the business device 104, for example, via the business device graphical user interface 116, to edit the generated loyalty rewards. Upon receiving the request, the loyalty reward system 102 is configured to retrieve and display the web form, for example, the web form 800 (shown in FIG. 8), corresponding to the generated loyalty rewards on the business device display 114 of the business device 104. The business device 104 is configured to modify the information previously associated the one or more attributes based on which the previous loyalty rewards were generated. Upon obtaining the modified information, the loyalty reward system 102 is configured to generate an updated digital loyalty reward based on the modified information associated with the one or more attributes.

In accordance with various embodiments, the loyalty reward system 102 is configured to receive, from the customer device 103, a request to redeem the loyalty rewards. To this end, upon receiving the request, the loyalty reward system 102 is configured to determine a predefined threshold number associated with the loyalty reward for which the request is received. For example, the predefined threshold number may indicate a minimum number of loyalty points required by the customer device 103 to redeem a corresponding loyalty reward. In an embodiment, the loyalty reward system 102 is configured to enable the business device 104 to define the predefined threshold number associated with the corresponding loyalty reward. In an embodiment, the predefined threshold number is defined, for example, via the graphical element 806 (shown in FIG. 8). Upon receiving the request, the loyalty reward system 102 is configured to compare the predefined threshold number with a number of loyalty points associated or available with the customer device 103. Upon determination that the number of loyalty points associated with the customer device 103 meets the predefined threshold number, the loyalty reward system 102 is configured to provide one or more instructions to the customer device 103 to enable the customer to redeem the loyalty reward in lieu of the predefined threshold number of the loyalty points. In an embodiment, when the number of loyalty points associated with the customer device 103 does not meet the predefined threshold number, the loyalty reward system 102 sends an error message to the customer device 103.

In accordance with various embodiments, the loyalty reward system 102 is configured to track customer behavior activity on each of the one or more customer devices 103 to obtain one or more customer behavior parameters. The one or more customer behavior parameters may include, but not limited to, personal details (for example, birth date) of the customer, a number of times the application supported by or associated with the loyalty reward system is referred by the customer device 103, registration of the customer device 103 on the application supported by or associated with the loyalty reward system 102, or following of digital profiles of one or more businesses by a customer via the customer device 103, on the application supported by the loyalty reward system 102.

In accordance with various embodiments, the loyalty reward system 102 is configured to compare the tracked the one or more customer behavior parameters on each of the customer device 130 with the predefined behavior parameters, to provide the bonus points. For example, loyalty reward system 102 is configured to define the behavior parameters and the corresponding number of bonus points for each of the behavior parameters. In an embodiment, the loyalty reward system 102 is configured to store the predefined behavior parameters and the corresponding number of bonus points in the system memory 126. In accordance with various embodiments, the loyalty reward system 102 is configured to provide the bonus points to the customer device 103 when the one or more tracked customer behavior parameters meet the predefined behavior parameters. In an embodiment, the customer device 103 may receive the corresponding number of bonus points, for example, in the digital wallet associated with the customer device 103, from the loyalty reward system 102.

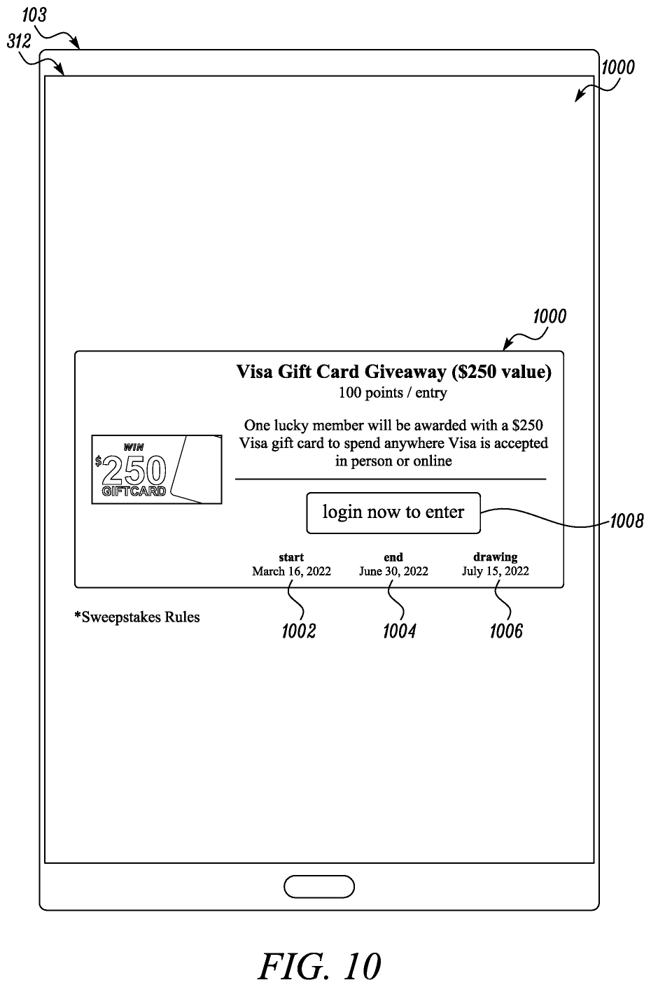

In accordance with various embodiments, the loyalty reward system 102 is configured to receive from the customer device 103, a request to redeem the bonus points to participate in the one or more sweepstake contests. To this end, upon receiving the request, the loyalty reward system 102 is configured to determine a predefined bonus threshold number associated with the one or more sweepstake contests. For example, the bonus threshold may be a minimum number of the bonus points that are required by the customer of the respective customer device 103 to participate in one or more sweepstake contests. The loyalty reward system 102 is configured to define one or more bonus threshold numbers corresponding to the one or more sweepstake contests. Upon determination that the number of bonus points associated with the customer device 103 meets the predefined bonus threshold number, the loyalty reward system 102 is configured to provide one or more instructions to the customer device 103 to enable the customer to participate in the one or more sweepstake contests. In an embodiment, when the number of bonus points associated with the customer device 103 does not meet the predefined bonus threshold number, the loyalty reward system 102 sends an error message to the customer device 103. For example, FIG. 10 illustrates a sweepstake contest 1000, where a visa gift card worth of $250 would be given to one lucky customer. A start date 1002, an end date 1004, and a drawing date 1006 of the sweepstake contest is also mentioned, as shown in FIG. 10. The respective customer devices 103 can login to enter the sweepstake contest, for example via one or more graphical elements 1008 on the customer device graphical user interface 312.

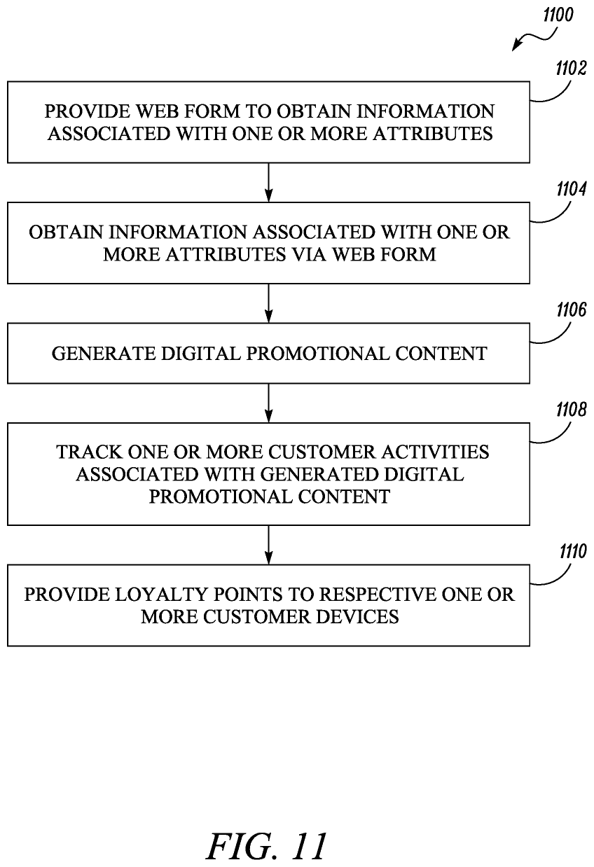

FIG. 11 illustrates an exemplary method 1100 to provide the loyalty points to one or more customers. The one or more business device 104 are configured to initiate a request to provide loyalty points. At operation 1102, the method begins with the loyalty reward system 102 providing a web form to obtain information associated with one or more attributes of one or more promotional offers provided by a business. At operation 1104, the loyalty reward system 102 obtains information associated with the one or more attributes from the one or more business devices. Further, at operation 1106, the loyalty reward system 102 generates the digital promotional content based on the obtained information. The loyalty reward system 102 is further configured to track the one or more customer activities associated with generated digital promotional content, at operation 1108. The one or more customer activities are tracked by determining one or more of: a number of times the generated digital promotional content is shared on each of the one or more customer devices, a number of times the generated digital promotional content was utilized to redeem the one or more promotional offers on each of the one or more customer devices, a number of times the generated digital promotional content was viewed on the one or more customer devices, and a number of times the generated digital promotional content was saved on each of the one or more customer devices. Further, at operation 1110, the loyalty reward system 102 provides the loyalty points to respective one or more customer devices 103, when the one or more customer activities meet predefined activity conditions. The predefined activity conditions are defined based on preferences of the business, and each of the one or more customer devices are configured to receive the loyalty points.

The system and the method of the present disclosure provides a simple, low cost, and efficient solution to enable the business devices to provide loyalty points, to generate the digital promotional content and to track the one or more customer activities on the customer devices. Further, the present disclosure allows the business devices to modify the promotional content for each of the customer device based on the tracked activities on that customer devices.

In the hereinbefore specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings. The benefits, advantages, solutions to problems, and any element(s) that may cause any benefit, advantage, or solution to occur or become more pronounced are not to be construed as a critical, required, or essential feature or elements of any or all the claims. The invention is defined solely by the appended claims including any amendments made during the pendency of this application and all equivalents of those claims as issued.

Moreover, in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element preceded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way but may also be configured in ways that are not listed.

It will be appreciated that some embodiments may be comprised of one or more generic or specialized processors (or “processing devices”) such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (example, comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

1. (canceled)

2. The distributed system of claim 21, wherein the system processor of the loyalty reward system is further configured to:
receive a request, via the system transceiver, from the one or more business devices, to edit the generated digital promotional content;
retrieve a web form corresponding to the generated promotional content for which the request to edit is received;
modify the information previously associated with the one or more attributes of the one or more promotional offers in the retrieved web form; and
generate an updated digital promotional content to be displayed via the customer device graphical user interface of the one or more customer devices based on the modified information associated with the one or more attributes.

3. (canceled)

4. The distributed system of claim 21, wherein the one or more customer behavior parameters include at least one of: a number of times the application supported by the loyalty reward system is referred by the customer device and a registration of the customer device on the application supported by the loyalty reward system.

5. The distributed system of claim 21, wherein the system processor of the loyalty reward system is further configured to:
generate the loyalty reward to redeem the loyalty points by:
providing, via the system transceiver, to a business device of the one or more business devices, a web form to obtain information associated with one or more attributes of one or more loyalty rewards offered by the business;
obtaining, via the system transceiver, from the business device, information associated with the one or more attributes via the web form;
display, via the customer device graphical user interface of the one or more customer devices, the generated loyalty rewards; and
receive, via the system transceiver, from a customer device of the one or more customer devices, a request to redeem the loyalty rewards when a number of loyalty points associated with the respective customer device meets a predefined threshold number.

6. The distributed system of claim 21, wherein the one or more attributes of the one or more promotional offers include a title, an image, descriptive details, a start date, and an end date of the one or more promotional offers.

7. The distributed system of claim 21, wherein the one or more customer activities include at least one of: shopping trends of a customer captured by the customer device, a number of times the digital promotional content is referred via the customer device and a number of times the one or more promotional offers is redeemed by the customer device.

8. The distributed system of claim 21, wherein the system processor of the loyalty reward system is further configured to:
receive a request, via the system transceiver, from the one or more business devices, to update the predefined activity conditions; and
update the predefined activity conditions based on the received request.

9. The distributed system of claim 21, wherein the system processor of the loyalty reward system is further configured to:
receive a request, via the system transceiver, from the one or more business devices, to generate one or more codes selected from a group comprising one or more of the QR code and a barcode, for the one or more customer devices, to redeem the one or more promotional offers on the one or more customer devices, wherein the one or more codes are single use or multi use; and
transmit, via the system transceiver, the generated one or more codes corresponding to the one or more promotional offers on each of the one or more customer devices.

10. (canceled)

11. The distributed method of claim 22, wherein the distributed method further comprises:
receiving a request, via the system transceiver, from the one or more business devices, to edit the generated digital promotional content;
retrieving a web form corresponding to the generated promotional content for which the request to edit is received;
modifying the information previously associated with the one or more attributes of the one or more promotional offers in the retrieved web form; and
generating an updated digital promotional content to be displayed via the customer device graphical user interface of the one or more customer devices based on the modified information associated with the one or more attributes.

12. (canceled)

13. The distributed method of claim 22, wherein the one or more customer behavior parameters include at least one of: a number of times the application supported by the loyalty reward system is referred by the customer device and a registration of the customer device on the application supported by the loyalty reward system.

14. The distributed method of claim 22, wherein the distributed method further comprises:
generating the loyalty reward to redeem the loyalty points by:
providing, via the system transceiver, to a business device of the one or more business devices, a web form to obtain information associated with one or more attributes of one or more loyalty rewards offered by the business;
obtaining, via the system transceiver, from the business device, information associated with the one or more attributes via the web form;
display, via the customer device graphical user interface of the one or more customer devices, the generated loyalty rewards; and
receive, via the system transceiver, from a customer device of the one or more customer devices, a request to redeem the loyalty rewards when a number of loyalty points associated with the respective customer device meets a predefined threshold number.

15. The distributed method of claim 22, wherein the one or more attributes of the one or more promotions include a title, an image, descriptive details, a start date, and an end date of the one or more promotional offers.

16. The distributed method of claim 22, wherein the one or more customer activities include at least one of: shopping trends of a customer captured by the customer device, a number of times the digital promotional content is referred via the customer device, and a number of times the one or more promotional offers is redeemed by the customer device.

17. The distributed method of claim 22, wherein the distributed method further comprises:
receiving a request, via the system transceiver, from the one or more business devices, to update the predefined activity conditions; and
updating the predefined activity conditions based on the received request.

18. The distributed method of claim 22, wherein the distributed method further comprises:
receiving a request, via the system transceiver, from the one or more business devices, to generate one or more codes selected from a group comprising one or more of the QR code and a barcode for the one or more customer devices to redeem the one or more promotional offers on the one or more customer devices, wherein the one or more codes are single use or multi use; and
transmitting, via the system transceiver, the generated one or more codes corresponding to the one or more promotional offers on each of the one or more customer devices.

19. The distributed method of claim 14, wherein the generated loyalty rewards are valid at one or more participating business locations.

20. The distributed system of claim 5, wherein the generated loyalty rewards are valid at one or more participating business locations.

21. A distributed system for providing a combination of loyalty points generated by one or more business devices and bonus points generated directly by a loyalty reward system to one or more customer devices, the system comprising:
the one or more business devices communicatively coupled to the loyalty reward system, for generating and allocating the loyalty points to the one or more customer devices, wherein each business device of the one or more business devices comprises:
a business device transceiver;
a business device graphical user interface;
a business device memory configured to store one or more instructions; and
a business device processor communicatively coupled to the business device transceiver, the business device graphical user interface, and the business device memory, wherein the business device processor is configured to execute the one or more instructions stored in the business device memory to:
capture, via the business device graphical user interface, information associated with one or more attributes of one or more promotional offers provided by the respective business,
capture, via the business device graphical user interface, data associated with predefined activity conditions and a corresponding number of the loyalty points to be provided to the one or more customer devices when one or more customer activities meet the predefined activity conditions, the predefined activity conditions defined based on preferences of the respective business, wherein the one or more customer activities includes:
a number of times a digital promotional content was viewed by each customer device of the one or more customer devices via a corresponding customer device graphical user interface, and
a number of times the digital promotional content was saved in a system memory of the loyalty reward system, and
communicate, via the business device transceiver, the loyalty points allocation to the loyalty reward system when the one or more customer activities meet the predefined activity conditions;
the loyalty reward system communicatively coupled to the one or more business devices, the loyalty reward system comprising:
a system transceiver;
the system memory configured to store one or more instructions; and
a system processor communicatively coupled to the system memory and the system transceiver, wherein the system processor is configured to execute the one or more instructions stored in the system memory to:
obtain, via the system transceiver, the information associated with the one or more attributes of the one or more promotional offers and the data associated with the predefined activity conditions and the corresponding number of the loyalty points,
generate the digital promotional content to be displayed on each customer device of the one or more customer devices based on the obtained information,
track, via the system transceiver, the one or more customer activities associated with the generated digital promotional content on each customer device of the one or more customer devices,
allocate, via the system transceiver, the loyalty points to the respective one or more customer devices when the one or more customer activities meet the predefined activity conditions, wherein the loyalty points correspond to a first set of reward points offered by the business,
track, via the system transceiver, customer behavior activity on each customer device of the one or more customer devices to obtain one or more customer behavior parameters, wherein the customer behavior parameters include the customer device following digital profiles associated with businesses on an application supported by the loyalty reward system,
allocate, via the system transceiver, bonus points to the respective one or more customer devices when the one or more customer behavior parameters meet predefined behavior parameters, wherein the bonus points correspond to a second set of reward points offered directly by the loyalty reward system and wherein the first set of reward points is different from the second set of reward points, and
receive, via the system transceiver, from a customer device of the one or more customer devices, a request to redeem the bonus points to participate in one or more sweepstake contests organized by the loyalty reward system when a number of the bonus points associated with the respective customer device meets a predefined bonus threshold number; and
the one or more customer devices communicatively coupled to the loyalty reward system for receiving the combination of the loyalty points generated by the one or more business devices and the bonus points generated directly by the loyalty reward system, each customer device of the one or more customer devices comprising:
a customer device transceiver;
the customer device graphical user interface;
a customer device memory configured to store one or more instructions; and
a customer device processor communicatively coupled to the customer device memory, the customer device graphical user interface, and the customer device transceiver, wherein the customer device processor is configured to execute the one or more instructions stored in the customer device memory to:
receive, via the customer device transceiver, a Quick Response (QR) code for redeeming the one or more promotional offers provided by the one or more business devices at a physical store corresponding to the one or more business devices,
obtain, via the customer device transceiver, the loyalty points from the one or more business devices when the one or more customer activities meet the predefined activity conditions,
utilize, via the customer device graphical user interface, the loyalty points for obtaining loyalty rewards offered by the respective one or more business devices,
obtain, via the customer device transceiver, the bonus points directly from the loyalty reward system when the one or more customer behavior parameters meet the predefined behavior parameters, and
redeem, via the customer device graphical user interface, the bonus points by participating in the one or more sweepstake contests organized by the loyalty reward system.

22. A distributed method for providing a combination of loyalty points generated by one or more business devices and bonus points generated directly by a loyalty reward system to one or more customer devices, the method comprising:
generating and allocating, by a business device processor of each business device of the one or more business devices, the loyalty points to the one or more customer devices by:
capturing, via a business device graphical user interface of the business device, information associated with one or more attributes of one or more promotional offers provided by the respective business,
capturing, via the business device graphical user interface, data associated with predefined activity conditions and a corresponding number of the loyalty points to be provided to the one or more customer devices when one or more customer activities meet the predefined activity conditions, the predefined activity conditions defined based on preferences of the respective business, wherein the one or more customer activities includes:
a number of times a digital promotional content was viewed by each customer device of the one or more customer devices via a corresponding customer device graphical user interface, and
a number of times the digital promotional content was saved in a system memory of the loyalty reward system, and
communicating, via a business device transceiver of the business device, the loyalty points allocation to the loyalty reward system when the one or more customer activities meet the predefined activity conditions;
obtaining, by a system processor of the loyalty reward system, the information associated with the one or more attributes of the one or more promotional offers and the data associated with the predefined activity conditions and the corresponding number of the loyalty points via a system transceiver of the loyalty reward system;
generating, by the system processor, the digital promotional content to be displayed on each customer device of the one or more customer devices based on the obtained information via the system transceiver;
tracking, by the system processor, the one or more customer activities associated with the generated digital promotional content on each customer device of the one or more customer devices via the system transceiver;
allocating, by the system processor, the loyalty points to the respective one or more customer devices when the one or more customer activities meet the predefined activity conditions via the system transceiver, wherein the loyalty points correspond to a first set of reward points offered by the business;
tracking, by the system processor, customer behavior activity on each customer device of the one or more customer devices to obtain one or more customer behavior parameters via the system transceiver, wherein the customer behavior parameters include the customer device following digital profiles associated with businesses on an application supported by the loyalty reward system;
allocating, by the system processor, bonus points to the respective one or more customer devices when the one or more customer behavior parameters meet predefined behavior parameters via the system transceiver, wherein the bonus points correspond to a second set of reward points offered directly by the loyalty reward system and wherein the first set of reward points is different from the second set of reward points;
receiving, by the system processor, from a customer device of the one or more customer devices, a request to redeem the bonus points to participate in one or more sweepstake contests organized by the loyalty reward system when a number of the bonus points associated with the respective customer device meets a predefined bonus threshold number; and
receiving, by a customer device processor of each customer device of the one or more customer devices, the combination of the loyalty points generated by the one or more business devices and the bonus points generated directly by the loyalty reward system by:
receiving, via a customer device transceiver of the customer device, a Quick Response (QR) code for redeeming the one or more promotional offers provided by the one or more business devices at a physical store corresponding to the one or more business devices,
obtaining, via the customer device transceiver, the loyalty points from the one or more business devices when the one or more customer activities meet the predefined activity conditions,
utilizing, via a customer device graphical user interface of the customer device, the loyalty points for obtaining loyalty rewards offered by the respective one or more business devices,
obtaining, via the customer device transceiver, the bonus points directly from the loyalty reward system when the one or more customer behavior parameters meet the predefined behavior parameters, and
redeeming, via the customer device graphical user interface, the bonus points by participating in the one or more sweepstake contests organized by the loyalty reward system.
